(19) United States
(12) Patent Application Publication
(10) Pub. No.: US 2026/0152182 A1
(43) Pub. Date: Jun. 4, 2026

(54) VEHICLE TOWING CONTROL DEVICE

(71) Applicant: SUBARU CORPORATION, Tokyo (JP)

(72) Inventor: Harunobu HORIGUCHI, Tokyo (JP)

(21) Appl. No.: 19/378,802

(22) Filed: Nov. 4, 2025

(30) Foreign Application Priority Data
Dec. 4, 2024 (JP) 2024-211088

(51) Int. Cl. B60W 30/18; B60D 1/18; B60D 1/24

(52) U.S. Cl. CPC B60W 30/18009; B60D 1/182; B60D 1/24; B60W 2420/403; B60W 2520/10; B60W 2554/802; B60W 2710/18; B60W 2720/10

(57) ABSTRACT

A vehicle towing control device is configured to be provided in a towing vehicle configured to tow and extricate a towed vehicle that is a vehicle in a stuck state, and includes a tow-rope-state-information acquisition device, a vehicle speed acquisition device, and a driving force control device. The tow-rope-state-information acquisition device is configured to acquire information regarding a state of a tow rope used for coupling the towed vehicle and the towing vehicle to each other. The vehicle speed acquisition device is configured to acquire information regarding a vehicle speed of the towing vehicle. The driving force control device is control a driving force of a driving source of the towing vehicle. The driving force control device controls the driving force of the driving source based on change information about the state of the tow rope or change information about the vehicle speed of the towing vehicle.

### CROSS-REFERENCE TO RELATED APPLICATIONS

The present application claims priority from Japanese Patent Application No. 2024-211088 filed on December 4, 2024, the entire contents of which are hereby incorporated by reference.

### BACKGROUND

The disclosure relates to vehicle towing control devices that control towing operations for towing and extricating vehicles, such as automobiles, stuck on snowy roads, unpaved roads, and the like.

A solution in the related art for rescuing a vehicle, such as an automobile, stuck in an unstable ground region, such as a snowy road, muddy terrain, or sandy terrain, involves, for example, towing the stuck vehicle by coupling the stuck vehicle to another vehicle in a stable ground region by using, for example, a rope.

Such a vehicle towing operation demands multiple simultaneous operations, such as an operation for controlling the timing for pressing the accelerator pedal (i.e., the timing for applying a driving force) of the vehicle at the towing side (also referred to as "towing vehicle") and an operation for controlling the vehicle speed of the towing vehicle. Thus, such a vehicle towing operation is known to demand a certain level of experience or skill.

On the other hand, vehicles, such as automobiles, in recent years are becoming automated by being equipped with control apparatuses called driving assist apparatuses, travel control apparatuses, or the like. A vehicle automatically and appropriately undergoes, for example, driving force control and braking control in accordance with the surrounding environment or the surrounding condition. In view of this, for example, it is highly convenient to be able to automate a towing operation performed by a towing vehicle and/or a towed vehicle.

In the related art, for example, Japanese Unexamined Patent Application Publication (JP-A) No. 2003-299205, JP-A 2004-345407, and JP-A 2015-174597 each disclose a technique in which, when towing is to be performed by coupling a towing vehicle to a towed vehicle by using a rope, the towing is controlled based on, for example, the looseness of the rope, the tension of the rope, or the vehicle speed.

For example, JP-A No. 2003-299205 mentioned above discloses that, when an electric vehicle is to be towed, the tension of a tow rope coupled to the towing vehicle is detected, and a regenerative braking force is controlled in accordance with the detected rope tension.

JP-A No. 2004-345407 mentioned above discloses determining whether a vehicle is a towed vehicle and performing acceleration-deceleration control and braking control based on a change in speed of the vehicle when the vehicle is a towed vehicle.

JP-A 2015-174597 mentioned above discloses detecting a change in distance between a towing vehicle and a towed vehicle if there is such a change, and performing acceleration-deceleration control or braking control to suppress contact of the tow rope with, for example, the ground.

### SUMMARY

An aspect of the disclosure provides a vehicle towing control device configured to be provided in a towing vehicle configured to tow and extricate a towed vehicle that is a vehicle in a stuck state. The vehicle towing control device includes a tow-rope-state-information acquisition device, a vehicle speed acquisition device, and a driving force control device. The tow-rope-state-information acquisition device is configured to acquire information regarding a state of a tow rope used for coupling the towed vehicle and the towing vehicle to each other. The vehicle speed acquisition device is configured to acquire information regarding a vehicle speed of the towing vehicle. The driving force control device is configured to control a driving force of a driving source of the towing vehicle. The driving force control device is configured to control the driving force of the driving source based on change information about the state of the tow rope or change information about the vehicle speed of the towing vehicle.

An aspect of the disclosure provides a vehicle towing control device configured to be provided in a towing vehicle configured to tow and extricate a towed vehicle that is a vehicle in a stuck state. The vehicle towing control device includes circuitry. The circuitry is configured to acquire information regarding a state of a tow rope used for coupling the towed vehicle and the towing vehicle to each other. The circuitry is configured to acquire information regarding a vehicle speed of the towing vehicle. The circuitry is configured to control a driving force of a driving source of the towing vehicle. The circuitry is configured to control the driving force of the driving source based on change information about the state of the tow rope or change information about the vehicle speed of the towing vehicle.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a block diagram illustrating a schematic configuration of a vehicle travel control apparatus including a vehicle towing control device according to an embodiment of the disclosure;

FIG. 2 is a flowchart illustrating the operation of the vehicle towing control device in FIG. 1;

FIG. 3 is a flowchart illustrating a subroutine of a drive control process (step S4 in FIG. 2) in the flowchart in FIG. 2;

FIG. 4 is an operation diagram schematically illustrating respective temporal change amounts of a state (rope length) of a tow rope, a driving force of a towing vehicle, and a vehicle speed during the operation of the vehicle towing control device according to the embodiment;

FIG. 5 is a schematic diagram schematically illustrating a temporal change when the vehicle towing control device according to this embodiment operates, and illustrates a state immediately after the towing vehicle and a towed vehicle are coupled to each other using the tow rope before a towing operation is performed;

FIG. 6 illustrates a state where the towing vehicle has traveled forward after the state in FIG. 5;

FIG. 7 illustrates a state where the towing vehicle has further traveled forward after the state in FIG. 6; and

FIG. 8 illustrates a state where the towing vehicle has further traveled forward after the state in FIG. 7.

### DETAILED DESCRIPTION

None of the techniques in the related art disclosed in, for example, JP-A No. 2003-299205, JP-A 2004-345407, and JP-A 2015-174597 contemplates controlling an actively-performed towing operation, such as towing and extricating a vehicle stuck on, for example, a snowy road.

It is desirable to provide a vehicle towing control device that controls a towing operation for towing and extricating a vehicle, such as automobile, when the vehicle is stuck on a snowy road, an unpaved road, or the like, and that can safely and reliably extricate the stuck vehicle by automatically and appropriately performing towing control even when a user is not accustomed to a vehicle towing operation.

The disclosure will be described below with reference to an embodiment illustrated in the drawings. Each of the drawings used for the following description is schematic. Therefore, in these drawings, each component is illustrated in a size sufficient to be recognized in the drawings. In order to achieve this, for example, the dimensional relationships between members and the scales in the drawings may sometimes vary for each component. With regard to the number of components illustrated in each drawing, the shapes, the dimensional ratios, the relative positional relationships, and so on, the disclosure is not to be limited to those illustrated.

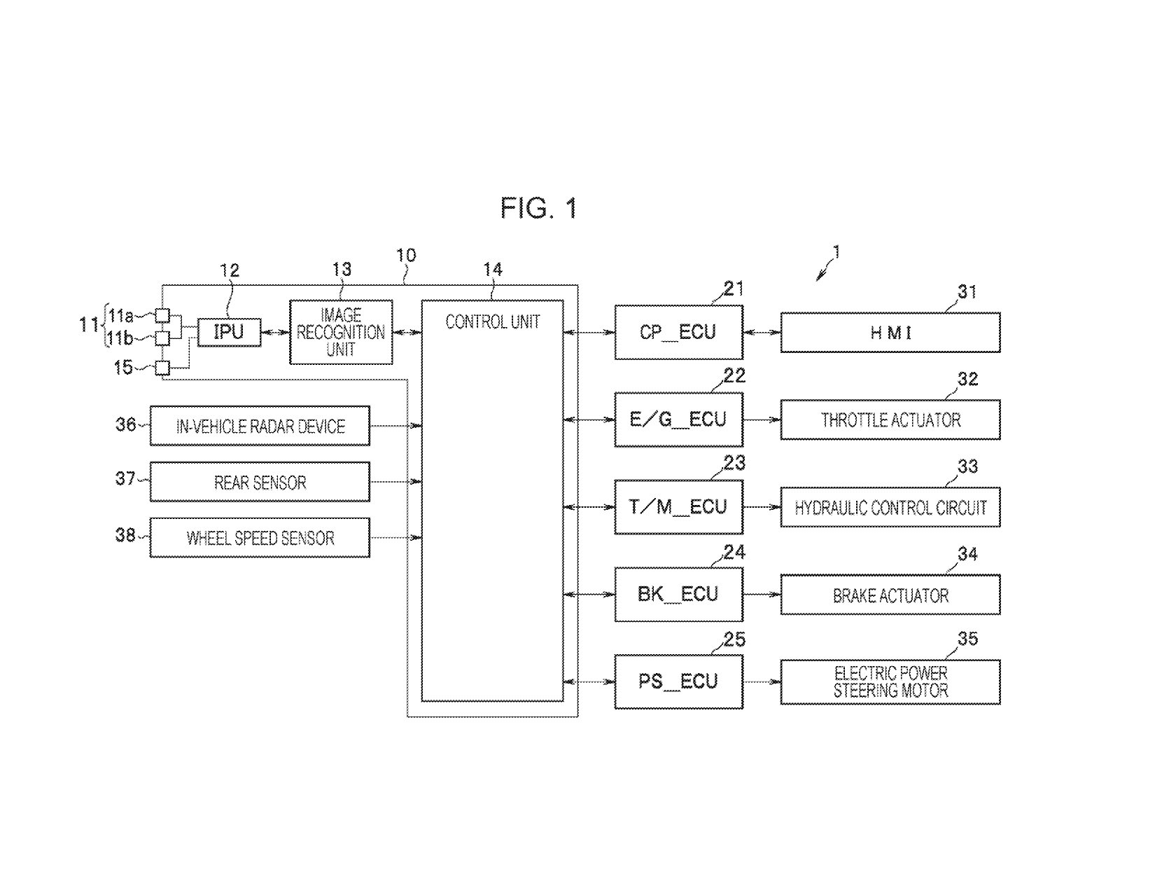

First, a schematic configuration of a vehicle travel control apparatus including a vehicle towing control device according to an embodiment of the disclosure will be described below with reference to FIG. 1. FIG. 1 is a block diagram illustrating the schematic configuration of the vehicle travel control apparatus including the vehicle towing control device according to the embodiment of the disclosure.

The basic configuration of the travel control apparatus illustrated in FIG. 1 is substantially similar to that of a travel control apparatus of the same kind in the related art. Therefore, in the following description, the illustration and the details of the general configuration of the travel control apparatus will be omitted, and the configuration of the vehicle towing control device according to this embodiment will be described below.

In this embodiment, a vehicle in a stuck state will be referred to as a towed vehicle, and a rescue vehicle that tows and extricates the towed vehicle will be referred to as a towing vehicle. It is assumed that the travel control apparatus including the vehicle towing control device according to this embodiment is installed in the towing vehicle.

The towing vehicle equipped with the travel control apparatus including the vehicle towing control device according to this embodiment tows the towed vehicle by being coupled to the towed vehicle using a tow rope. It is assumed that the towing operation in this case is controlled, so that the towing vehicle rescues the towed vehicle readily and smoothly by extricating the towed vehicle from the stuck state.

A vehicle travel control apparatus 1 including the vehicle towing control device according to this embodiment has a camera unit 10 that is an in-vehicle camera device fixed to a forward upper central area inside a vehicle cabin of the vehicle equipped with the travel control apparatus 1.

The camera unit 10 has, for example, a stereo camera 11, an image processing unit (IPU) 12, an image recognition unit 13, a control unit 14, and a rear observation camera 15.

The stereo camera 11 has two cameras, namely, a main camera 11a and a sub camera 11b. The main camera 11a and the sub camera 11b are disposed facing forward of the vehicle (in the traveling direction) at left and right symmetrical positions about the center in the vehicle width direction inside the vehicle cabin of the vehicle. Each of the main camera 11a and the sub camera 11b is an imaging device including, for example, an imaging optical system, an imaging element, such as a complementary metal oxide semiconductor (CMOS) image sensor, and a processing circuit that processes an imaging signal and the like.

According to this configuration, the stereo camera 11 causes the main camera 11a and the sub camera 11b to acquire, in predetermined synchronized imaging cycles, two pieces of image data from two different viewpoints targeted at the surrounding environment in a predetermined forward range outside the vehicle.

Based on the two pieces of image data acquired in this manner, stereo image data is generated. The stereo image data is treated as surrounding environment information indicating the environment surrounding the vehicle while the vehicle is traveling. The surrounding environment information (image data) generated in the stereo camera 11 is output to the image processing unit 12.

The rear observation camera 15 serves as, for example, a so-called monocular camera including a single camera. The rear observation camera 15 is located toward the rear window inside the vehicle cabin of the vehicle and near the center in the vehicle width direction, and is disposed facing rearward of the vehicle (in the direction opposite the traveling direction).

Similar to the two cameras (11a and 11b) of the stereo camera 11 mentioned above, the rear observation camera 15 is an imaging device including, for example, an imaging optical system, an imaging element, such as a CMOS image sensor, and a processing circuit that processes an imaging signal and the like. The rear observation camera 15 acquires image data targeted at the surrounding environment in a predetermined rearward range outside the vehicle. The image data acquired in this manner is treated as surrounding environment information indicating the environment surrounding the vehicle while the vehicle is traveling. The surrounding environment information (image data) generated in the rear observation camera 15 is also output to the image processing unit 12.

The image processing unit 12 is a component unit or a circuit unit that performs predetermined image processing on the surrounding environment information (i.e., the image data indicating the environment surrounding the vehicle while the vehicle is traveling) acquired by the stereo camera 11 and the rear observation camera 15. For example, the image processing unit 12 performs processing for detecting edges of various kinds of targets (such as objects or lane boundary lines) displayed in an image.

Based on an amount of positional displacement of corresponding edges between left and right images based on the stereo image data, the image processing unit 12 acquires distance information and generates image information (distance image information) including the distance information. The distance image information or the like generated in the image processing unit 12 is output to the image recognition unit 13. In this case, the camera unit 10 including the stereo camera 11 and the image processing unit 12 functions as a distance measurement device.

Based on the distance image information or the like input from the image processing unit 12, the image recognition unit 13 calculates, for example, the road curvature [1/m] of left and right boundary lines of a traveling road (vehicle traveling road) on which the vehicle travels, as well as the width (lane width) between the left and right boundary lines. The road curvature and the lane width are determined by using various known methods.

The image recognition unit 13 performs predetermined pattern matching based on the image information acquired by the stereo camera 11 or the rear observation camera 15, so as to recognize an object, such as a three-dimensional object (e.g., a guardrail or a curb, and another surrounding vehicle) extending along the road, in addition to recognizing, for example, the condition of the road surface (referred to as "road surface condition" hereinafter) around the vehicle.

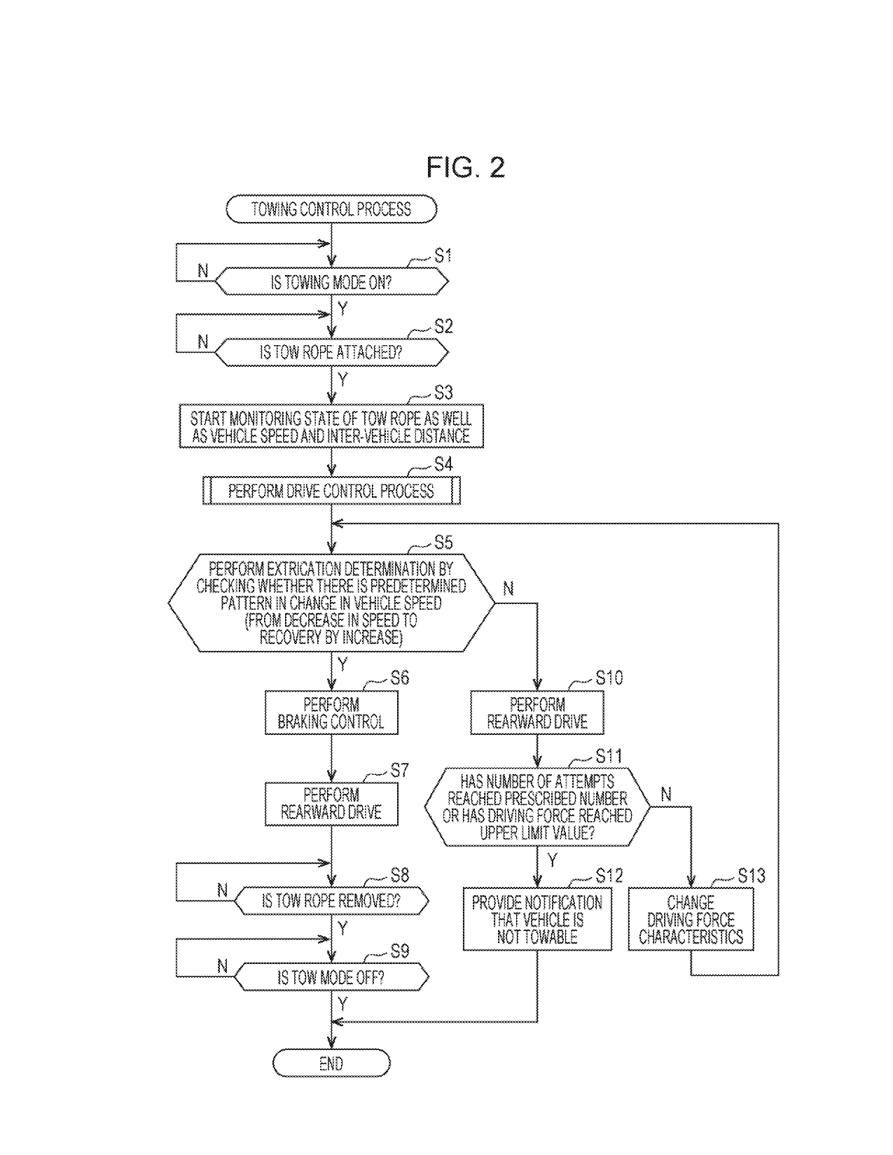

In addition, the image recognition unit 13 further recognizes a tow rope 50 (see, for example, FIG. 2) to be described later and acquires, for example, temporal change information about the state of the tow rope 50 (which will be described in detail later).

The three-dimensional object recognition by the image recognition unit 13 involves, for example, recognizing the type of the three-dimensional object, the height of the three-dimensional object, the width of the three-dimensional object, the distance from the vehicle to the three-dimensional object, the moving speed of the three-dimensional object, the relative speed between the three-dimensional object and the vehicle, the relative distance between three-dimensional objects (e.g., the transverse distance between a roadside curb and a lane boundary line near the roadside curb). Moreover, for example, when a towing mode (to be described later) is set, the image recognition unit 13 acquires temporal change information about the distance (inter-vehicle distance) from the towing vehicle (vehicle) to the towed vehicle (three-dimensional object).

Examples of the road surface condition to be recognized by the image recognition unit 13 include a condition where the road surface is wet due to rain, snowmelt, or the like, a rainfall condition, a snowfall condition, a compacted snow condition, a frozen road surface condition, and an unstable ground condition, such as snow-covered ground, muddy ground, or sandy ground. Any of these road surface conditions is estimated based on, for example, an image luminance difference.

The various kinds of information recognized by the image recognition unit 13 are output as surrounding environment information to the control unit 14. In this case, the camera unit 10 including the image recognition unit 13 functions as a surrounding environment recognition device that recognizes the surrounding environment of the vehicle.

In the vehicle travel control apparatus 1 including the vehicle towing control device according to this embodiment, the stereo camera 11 and the rear observation camera 15 in the camera unit 10 also function as a tow-rope-state-information acquisition device configured to acquire information about the state of the tow rope 50 that couples the towed vehicle and the towing vehicle to each other.

In this case, the surrounding environment information (i.e., the image data in which the tow rope 50 appears) acquired by each of the stereo camera 11 and the rear observation camera 15 undergoes predetermined image processing by the image processing unit 12, so as to be acquired as information about the state of the tow rope 50 by the image recognition unit 13.

The control unit 14 is a component unit of a circuit unit that is included in the camera unit 10, controls the camera unit 10, and performs integrated control of the entire travel control apparatus 1 including the vehicle towing control device according to this embodiment.

The control unit 14 is coupled to various kinds of control units, such as a cockpit control unit (CP_ECU) 21, an engine control unit (E/G_ECU) 22, a transmission control unit (T/M_ECU) 23, a brake control unit (BK_ECU) 24, and a power steering control unit (PS_ECU) 25, via an in-vehicle communication line, such as a controller area network (CAN).

The CP_ECU 21 is coupled to a human machine interface (HMI) 31 disposed near the driver seat. The HMI 31 has command switches for executing various kinds of driving assist control, a mode switch for switching between operation modes, a steering touch sensor that detects a steering-wheel holding state of a driver who drives the vehicle, a driver monitoring system (DMS) that performs face recognition on the driver, detects the line of sight thereof, and so on, an in-vehicle monitoring system including an in-vehicle camera that recognizes an occupancy state of occupants including the driver, a touch-sensitive display device (visual display device), a combination meter, and a sound output device (auditory display device) including a loudspeaker.

Upon receiving a control signal from the control unit 14, the CP_ECU 21 appropriately notifies the driver of various kinds of warnings with respect to a leading vehicle and the like and various kinds of information about the execution status of driving assist control, the surrounding environment of the vehicle, and so on in accordance with display, sound, and/or the like through the HMI 31. Moreover, the CP_ECU 21 outputs, to the control unit 14, various kinds of input information, such as an on or off mode with respect to various kinds of driving assist control, input by the driver via the HMI 31.

The output side of the E/G_ECU 22 is coupled to, for example, a throttle actuator 32 of an electronic control throttle. The input side of the E/G_ECU 22 is coupled to various kinds of sensors, such as an accelerator sensor (not illustrated).

The E/G_ECU 22 is a driving force control device that controls the driving of the throttle actuator 32 to generate or suppress a driving force of a driving source (such as the engine) of the vehicle based on a control signal from the control unit 14, a detection signal from any of the various kinds of sensors, or the like. Accordingly, the E/G_ECU 22 adjusts the intake airflow of the engine to cause the engine to generate a desired output. Moreover, the E/G_ECU 22 outputs a signal, such as an accelerator opening signal, detected by the corresponding one of the sensors to the control unit 14.

When the towing mode (to be described later) is set, the E/G_ECU 22 (driving force control device) controls the driving force of the driving source (which will be described in detail later) based on, for example, temporal change information about the state of the tow rope 50, temporal change information (i.e., information acquired based on an output from a wheel speed sensor 38 to be described later) about the vehicle speed of the towing vehicle, or temporal change information about the inter-vehicle distance between the towing vehicle and the towed vehicle.

The output side of the T/M_ECU 23 is coupled to a hydraulic control circuit 33. The input side of the T/M_ECU 23 is coupled to various kinds of sensors, such as a shift position sensor (not illustrated).

The T/M_ECU 23 performs hydraulic control on the hydraulic control circuit 33 based on, for example, an engine torque signal estimated by the E/G_ECU 22 or a detection signal from any of the various kinds of sensors. Accordingly, the T/M_ECU 23 actuates friction coefficient elements, pulleys, and so on provided in an automatic transmission, so as to shift an engine output at a desired gear ratio. The T/M_ECU 23 outputs a signal, such as a shift position signal detected by any of the various kinds of sensors, to the control unit 14.

The output side of the BK_ECU 24 is coupled to a brake actuator 34 for adjusting the brake hydraulic pressures to be output to brake wheel cylinders provided in the respective wheels. The input side of the BK_ECU 24 is coupled to various kinds of sensors, such as a brake pedal sensor, a yaw rate sensor, a front-rear acceleration sensor, and a vehicle speed sensor, which are not illustrated.

The BK_ECU 24 is a brake device that performs braking control on the vehicle by performing drive control on the brake actuator 34 based on a control signal from the control unit 14 or a detection signal from any of the various kinds of sensors. Accordingly, the BK_ECU 24 appropriately causes the respective wheels to generate braking forces for performing, for example, forced braking control or yaw rate control on the vehicle. The BK_ECU 24 outputs, to the control unit 14, signals indicating the status of a braking operation, the yaw rate, the front-rear acceleration, the vehicle speed (of the vehicle), and so on detected by the various kinds of sensors.

The output side of the PS_ECU 25 is coupled to an electric power steering motor 35 that applies, to a steering mechanism, steering torque based on a rotational force of a motor. The input side of the PS_ECU 25 is coupled to various kinds of sensors, such as a steering torque sensor and a steering angle sensor.

The PS_ECU 25 is a steering device that performs steering control on the vehicle by performing drive control on the electric power steering motor 35 based on a control signal from the control unit 14 or a detection signal from any of the various kinds of sensors. Accordingly, the PS_ECU 25 generates steering torque with respect to the steering mechanism. The PS_ECU 25 outputs, to the control unit 14, signals indicating the steering torque and the steering angle detected by the various kinds of sensors.

The control unit 14 is coupled to various kinds of sensors, such as an in-vehicle radar device 36, a rear sensor 37, and a wheel speed sensor 38.

The in-vehicle radar device 36 includes multiple sensors (e.g., millimeter wave radars). Each millimeter wave radar outputs a radio wave to an object, receives a reflected wave of the radio wave from the object, and analyzes the reflected wave, so as to detect, for example, a three-dimensional obstacle existing around the vehicle. Examples of a three-dimensional object that may be detected by each millimeter wave radar include a pedestrian, an adjacent running vehicle, a trailing vehicle, as well as a structural object (including a three-dimensional object such as a curb, a guardrail, a wall of a building, or vegetation) provided on, for example, the roadside. In this case, each millimeter wave radar detects, as specific information about the three-dimensional object, the width of the three-dimensional object, a representative position of the three-dimensional object, as well as a relative position, relative distance, relative speed and so on with respect to the vehicle. In this case, the in-vehicle radar device 36 functions as a distance measurement device.

The sensors (such as the millimeter wave radars) included in the in-vehicle radar device 36 are disposed at, for example, the left and right sides (referred to as "left and right front sensors") of the front bumper and the left and right sides (referred to as "left and right rear sensors") of the rear bumper. The left and right front sensors detect, as surrounding environment information, three-dimensional objects that exist in regions diagonally forward and lateral to the vehicle and that are difficult to recognize with the image of the stereo camera 11. The left and right rear sensors detect, as surrounding environment information, three-dimensional objects that exist in regions diagonally rearward and lateral to the vehicle and that are difficult to recognize with the left and right front sensors.

Accordingly, in this embodiment, the in-vehicle radar device 36 functions as a surrounding environment recognition device that recognizes the environment surrounding the vehicle. The information acquired by each sensor of the in-vehicle radar device 36 is transmitted to the image recognition unit 13 via the control unit 14.

The rear sensor 37 includes, for example, a sonar device that measures the distance to a target object and the shape thereof by using an ultrasonic wave. For example, one or more rear sensors 37 are disposed on the rear bumper. The rear sensor 37 detects, as surrounding environment information, a three-dimensional object that exists in a region rearward of the vehicle and that is difficult to recognize with the left and right rear sensors. Accordingly, in this embodiment, the rear sensor 37 functions as a surrounding environment recognition device that recognizes the environment surrounding the vehicle.

The coordinates of each target object outside the vehicle contained in each of the surrounding environment information recognized by the image recognition unit 13, the surrounding environment information recognized by the in-vehicle radar device 36, and the surrounding environment information recognized by the rear sensor 37 are converted by the control unit 14 into coordinates in a three-dimensional coordinate system with the vehicle center as the origin.

The wheel speed sensor 38 detects a pulse signal (wheel speed pulse) generated in proportion to the rotation speed of each wheel (normally, each of four wheels) of the vehicle, so as to detect the wheel rotation speed. The wheel speed sensor 38 functions as a vehicle speed acquisition device that acquires information about the vehicle speed.

The pieces of information acquired by these various kinds of sensors (36, 37, and 38) are transmitted to the control unit 14, and the control unit 14 executes vehicle travel control. In this case, the travel control is appropriately performed on the vehicle and involves, for example, the E/G_ECU 22 performing engine output control and torque distribution control for the drive wheels, the T/M_ECU 23 performing forward or rearward traveling direction control by controlling the transmission, and the BK_ECU 24 executing individual braking control (brake control) on each wheel.

When the towing mode (to be described later) is set, for example, the control unit 14 also functions as an extrication determination device that determines whether the towed vehicle has been extricated from the stuck state based on temporal change information about the vehicle-speed-related information acquired by the wheel speed sensor 38.

The various kinds of sensors for acquiring surrounding environment information may include, in addition to those mentioned above, for example, a light detection and ranging (LiDAR) device that measures the distance to a target object and the shape thereof by using laser light.

The stereo camera 11 mentioned above is mainly configured to observe a predetermined forward field of view. Additionally, multiple camera devices of the same kind may be provided to observe predetermined lateral and rearward fields of view. Accordingly, the entire range around the vehicle can be observed.

The image recognition unit 13, the control unit 14, the CP_ECU 21, the E/G_ECU 22, the T/M_ECU 23, the BK_ECU 24, the PS_ECU 25, and so on are entirely or partially configured by a processor including hardware.

The processor is known to include, for example, a central processing unit (CPU), a random access memory (RAM), a read only memory (ROM), a non-volatile memory, and non-volatile storage, in addition to a non-transitory computer readable medium, as well as peripheral devices and so on.

In the ROM, the non-volatile memory, the non-volatile storage, and so on, a software program to be executed by the CPU, fixed data, such as a data table, and so on are stored in advance. The CPU reads the software program stored in, for example, the ROM, loads the software program into the RAM, and executes the software program. Furthermore, for example, the software program appropriately refers to various kinds of data, so that the respective functions of the components and the component units (13, 14, 21, 22, 23, 24, and 25) mentioned above are implemented.

The processor may include, for example, a semiconductor chip, such as a field programmable gate array (FPGA). Furthermore, for example, the components and the component units (13, 14, 21, 22, 23, 24, and 25) mentioned above may each include an electronic circuit.

Moreover, as a computer program product, the software program may entirely or partially be recorded on a portable disk medium, such as a flexible disk, a compact disc-read only memory (CD-ROM), or a digital versatile disc-read only memory (DVD-ROM), or on a non-transitory computer readable medium, such as a card memory, a hard disk drive (HDD), or a solid state drive (SSD). Such a program is read by a computer in which the operation is entirely or partially executed. Alternatively, the program may be entirely or partially distributed or supplied via a communication network. A user can download and install the program into the computer via the communication network, or can install the program into the computer from a recording medium, so that the vehicle towing control device according to the embodiment of the disclosure can be readily realized.

The operation of the vehicle towing control device according to this embodiment having the above-described configuration will be described below with reference to FIGS. 2 to 8.

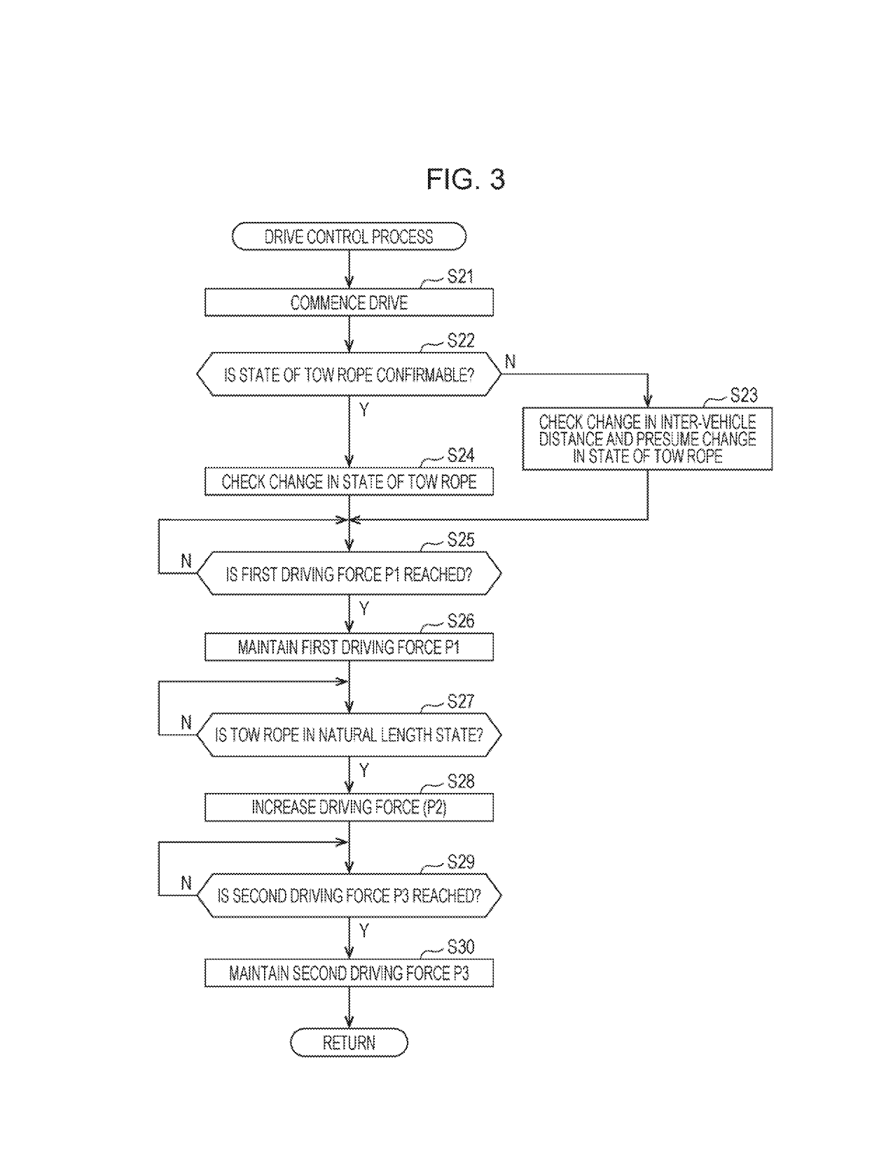

FIG. 2 is a flowchart illustrating the operation of the vehicle towing control device according to this embodiment. FIG. 3 is a flowchart illustrating a subroutine of a drive control process (step S4 in FIG. 2) in the flowchart in FIG. 2.

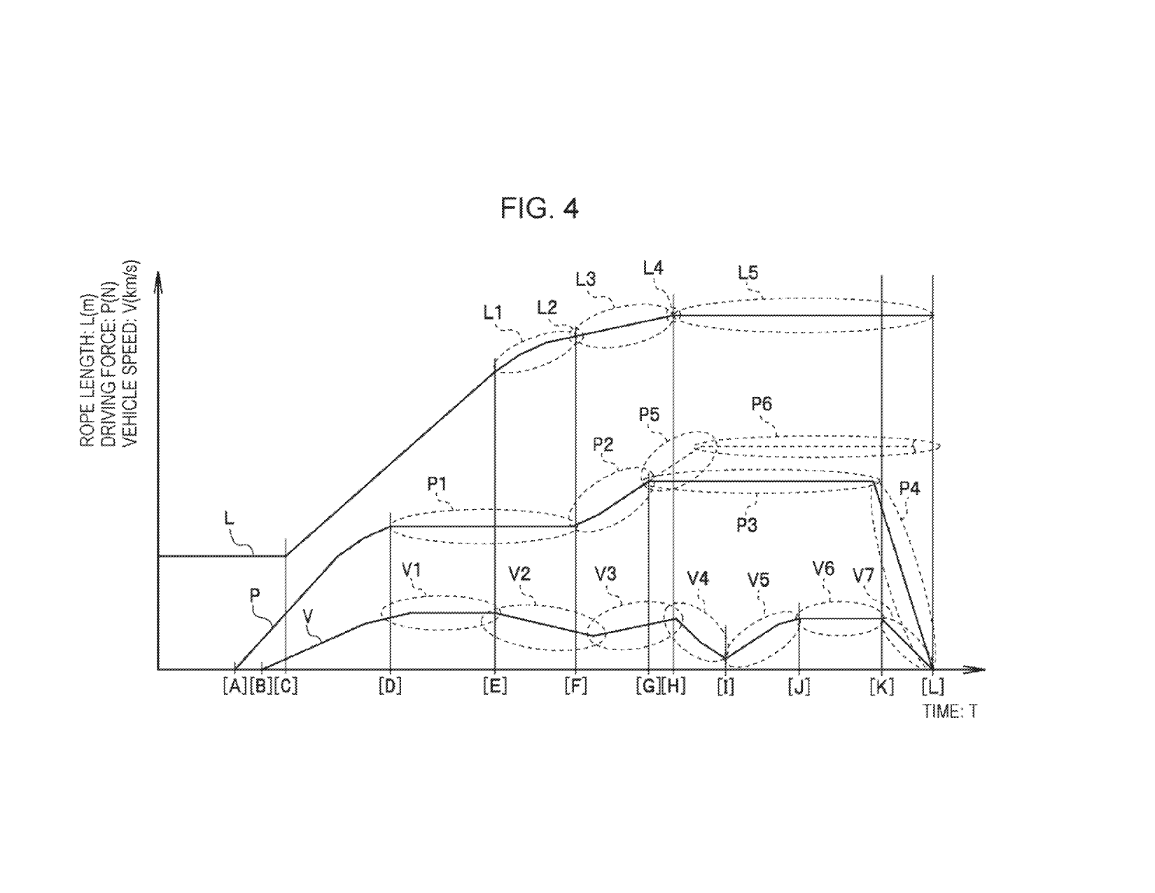

FIG. 4 is an operation diagram schematically illustrating respective temporal change amounts of the state (rope length L) of the tow rope, a driving force P of the towing vehicle, and a vehicle speed V during the operation of the vehicle towing control device according to this embodiment.

An example of an assumed situation where the vehicle towing control device according to this embodiment operates is a situation where a vehicle in a stuck state is set as a towed vehicle and the towed vehicle is rescued by being towed and extricated. In this case, the vehicle travel control apparatus including the vehicle towing control device according to this embodiment is equipped in the towing vehicle that tows the towed vehicle.

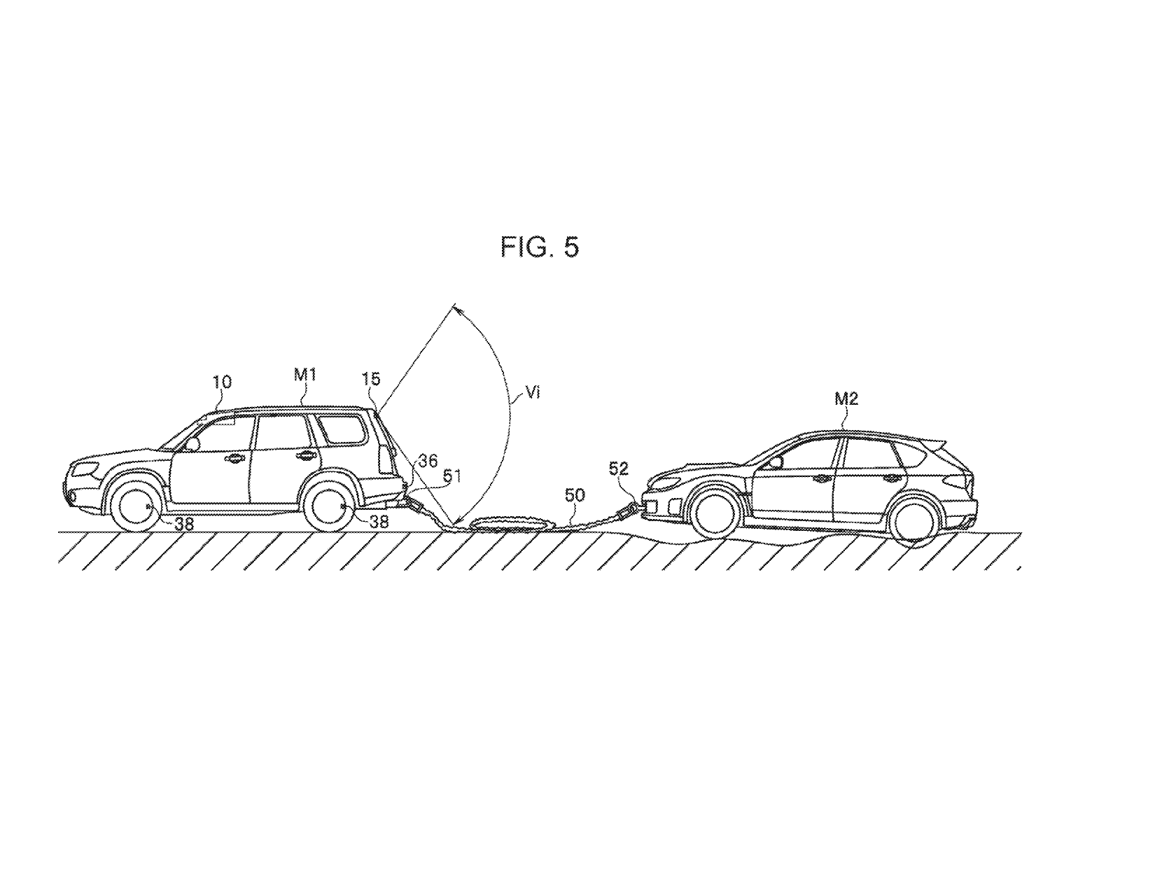

FIGS. 5 to 8 are schematic diagrams schematically illustrating a temporal change when the vehicle towing control device according to this embodiment operates.

In FIGS. 5 to 8, reference sign M1 denotes the towing vehicle, and reference sign M2 denotes the towed vehicle. The towing vehicle M1 has the camera unit 10 (including the rear observation camera 15) included in the vehicle travel control apparatus 1 including the vehicle towing control device according to this embodiment, the in-vehicle radar device 36, and the wheel speed sensor 38. Reference sign Vi schematically denotes a field-of-view range (imaging range) of the rear observation camera 15.

The towing vehicle M1 has a rear tow hook 51. The towed vehicle M2 has a front tow hook 52. Although not illustrated, the towing vehicle M1 may have a front tow hook 52, and the towed vehicle M2 may have a rear tow hook 51. The towing vehicle M1 and the towed vehicle M2 are coupled to each other by using the tow rope 50.

First, FIG. 5 illustrates a state immediately after the towing vehicle M1 and the towed vehicle M2 are coupled to each other with the tow rope before a towing operation is performed. In this case, in the state illustrated in FIG. 5, one end of the tow rope 50 is coupled to the rear tow hook 51 of the towing vehicle M1. The other end of the tow rope 50 is coupled to the front tow hook 52 of the towed vehicle M2. The tow rope 50 is in a loosened state and is placed on the ground. This state substantially corresponds to, for example, the state of the tow rope 50 in a period indicated by reference signs [A] to [E] in the operation diagram in FIG. 4. This state of the tow rope 50 will particularly be referred to as "slack state".

In this case, the distance between the towing vehicle M1 and the towed vehicle M2 is desirably equal to a distance sufficiently smaller than the overall distance of the tow rope 50 in a stretched state. Accordingly, the opposite ends of the tow rope 50 can be coupled to the tow hooks (51 and 52) of the vehicles (M1 and M2) while the tow rope 50 remains in a sufficiently loosened state.

The towing vehicle M1 is desirably disposed at a location where the ground is stable. On the other hand, it is assumed that the towed vehicle M2 is in a stuck state due to being in an unstable ground condition.

The tow rope 50 used for the towing operation has elasticity and is stretchable. In an unloaded condition, a state where the tow rope 50 is naturally stretched into a linear shape without slack will be referred to as a natural length state.

When the tow rope 50 is in the natural length state, a load applied in the direction for stretching the tow rope 50 (e.g., a load applied for towing by coupling the vehicles to each other using the tow rope 50) causes the tow rope 50 to stretch against its own elastic force. When the load applied to the tow rope 50 is removed, the tow rope 50 contracts due to its own elastic force. The tow rope 50 has such stretchability.

Accordingly, the natural length state of the tow rope 50 can be referred to as "contracted state". In contrast, when the tow rope 50 in its natural length state (contracted state) is stretched to its limit by further receiving a stretching load, such a state will be referred to as "stretched state".

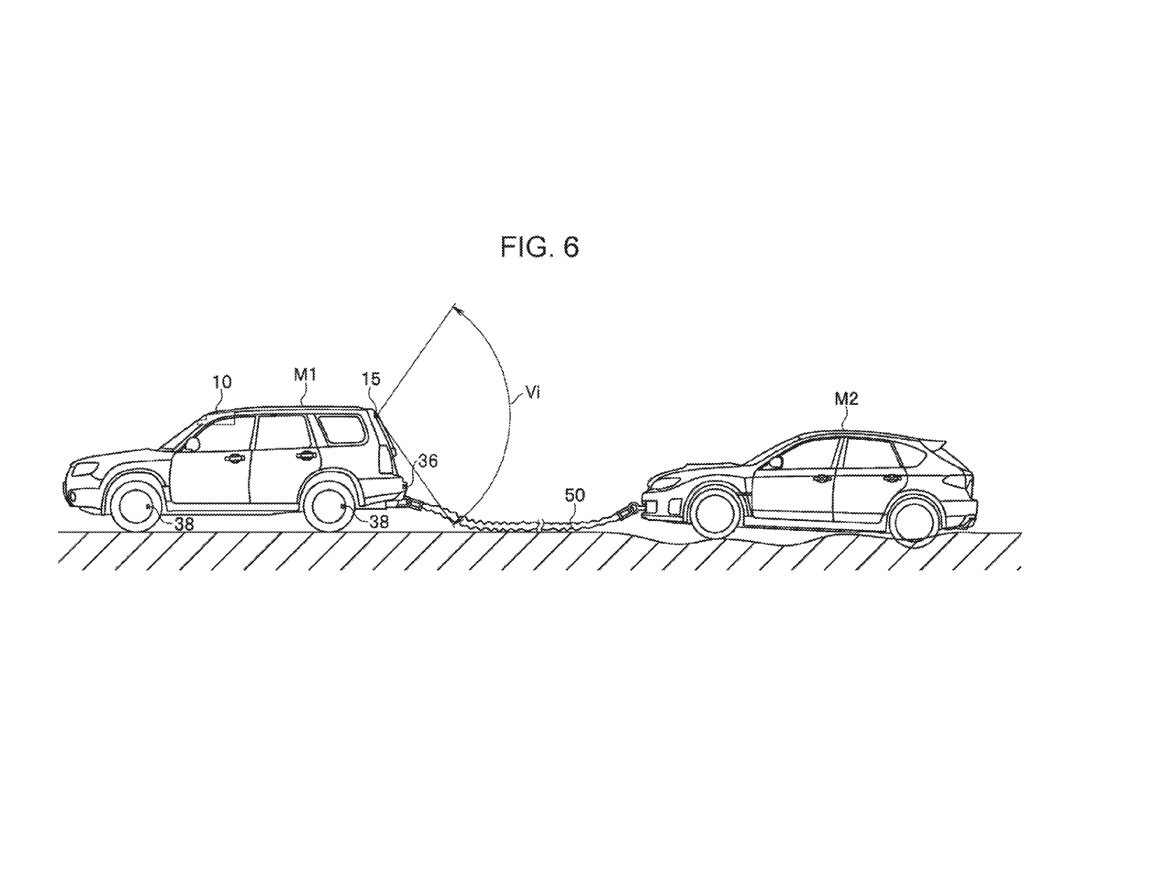

FIG. 6 illustrates a state where the towing vehicle has traveled forward after the state in FIG. 5. In this case, a scene where the loosened tow rope is gradually stretched to change toward a linear state is illustrated. This state substantially corresponds to, for example, a state in a period before and after the reference sign [E] in FIG. 4. In this case, the tow rope 50 is changing from the slack state to the stretched state.

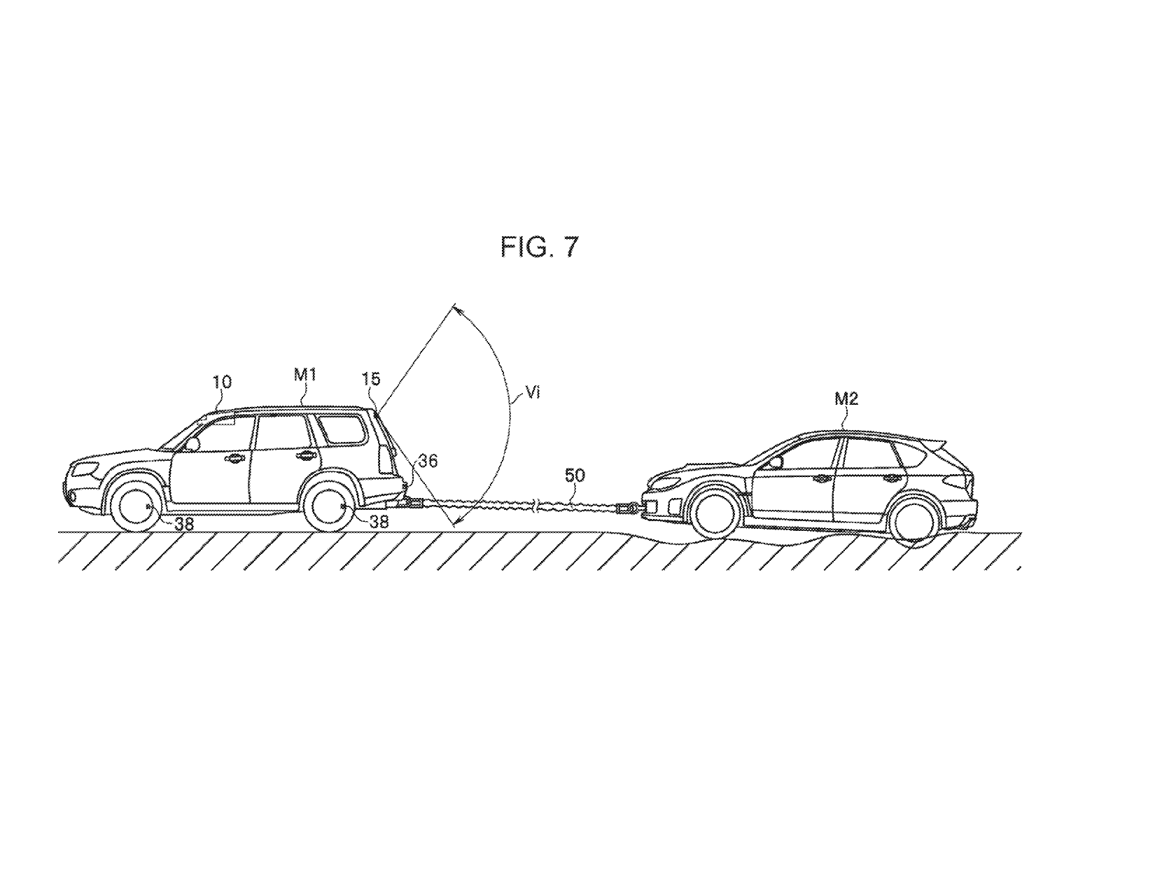

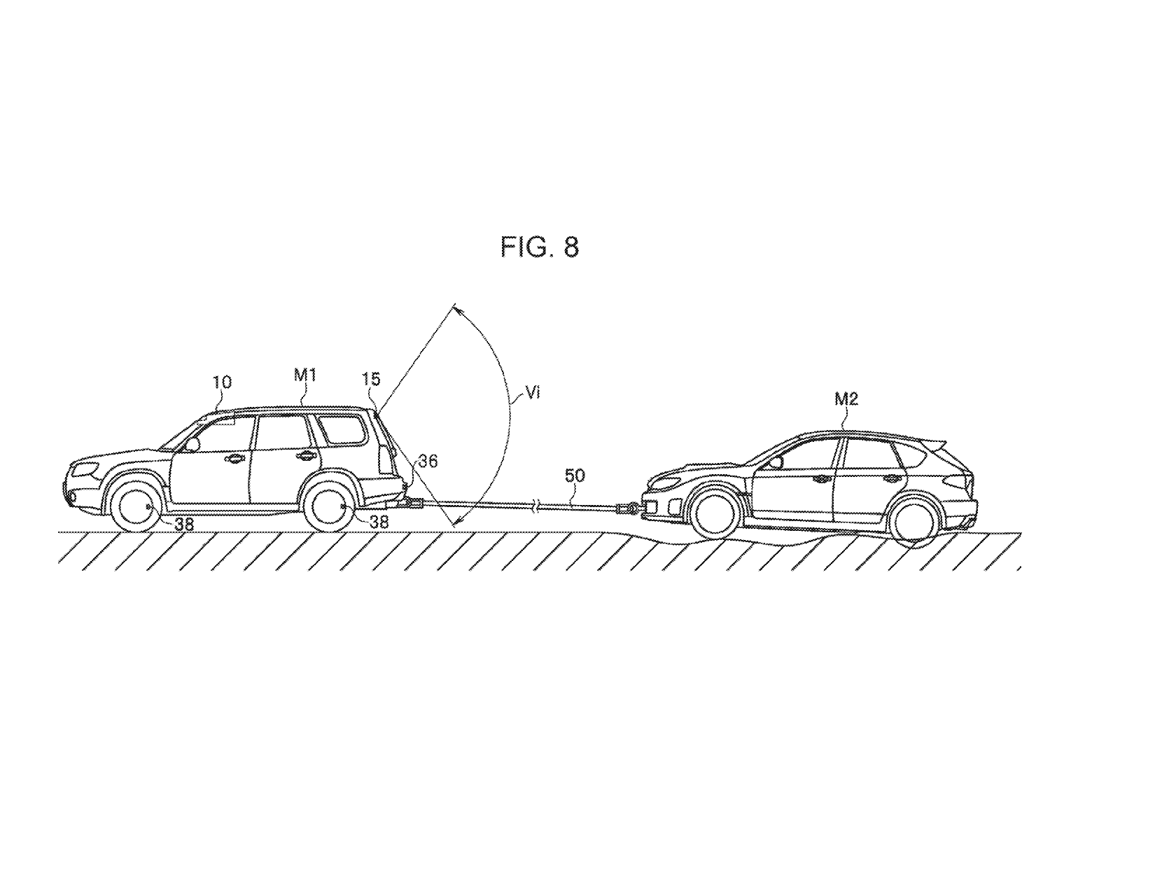

FIG. 7 illustrates a state where the towing vehicle has further traveled forward after the state in FIG. 6. In this case, the tow rope is stretched to its natural length with the slack removed and is thus in the natural length state (contracted state). Such a state substantially corresponds to a state in a period before and after the reference sign [F] in FIG. 4. FIG. 8 illustrates a state where the towing vehicle has further traveled forward after the state in FIG. 7. In this case, the tow rope is completely stretched against its elasticity by being further stretched from its natural length, and is thus in the stretched state. Such a state substantially corresponds to a state in a period of reference signs [H] to [K] in FIG. 4.

Next, a towing control process (flowcharts in FIGS. 2 and 3) by the vehicle towing control device according to this embodiment will be described below with reference to FIG. 4.

First, when the towing control process is to be executed in the towing vehicle M1 equipped with the vehicle travel control apparatus 1 including the vehicle towing control device according to this embodiment, the user uses the mode switch included in the HMI 31 to perform a towing-mode setting operation. In response to this operation, a towing-mode on signal is generated. This towing-mode on signal is output to the control unit 14 of the camera unit 10 via the CP_ECU 21.

In step S1 in FIG. 2, upon detecting the towing-mode on signal, the control unit 14 switches the travel mode of the travel control apparatus 1 to the towing mode. Then, the process proceeds to step S2.

After performing the towing-mode setting operation described above, the user performs a process for coupling the towing vehicle M1 and the towed vehicle M2 to each other by using the tow rope 50.

For example, as illustrated in FIG. 5, this process involves coupling one end of the tow rope 50 to the rear tow hook 51 of the towing vehicle M1, and also coupling the other end of the tow rope 50 to the front tow hook 52 of the towed vehicle M2.

In step S2, the control unit 14 checks whether the respective ends of the tow rope 50 are coupled to predetermined locations (such as the tow hooks 51 and 52) of the towing vehicle M1 and the towed vehicle M2. This checking of the coupled state is performed based on, for example, image data acquired by the stereo camera 11 or the rear observation camera 15.

In addition to the camera-based checking described above, a conceivable example of a technique for checking whether the tow rope 50 is coupled to the vehicles (M1 and M2) involves providing the tow hooks (51 and 52) of the vehicles with sensors (not illustrated).

Furthermore, after performing the process for checking whether the tow rope is coupled, the user may perform a manual operation on a predetermined switch (not illustrated) included in the HMI 31, so as to determine that the tow rope 50 is coupled. After it is confirmed that the tow rope 50 is coupled, the process proceeds to step S3.

In step S3, the control unit 14 uses, for example, the stereo camera 11, the rear observation camera 15, the in-vehicle radar device 36, or the wheel speed sensor 38 to start monitoring a temporal change in the state (rope length L) of the tow rope 50, temporal changes in the vehicle speed V and the inter-vehicle distance, and so on.

In step S4, the control unit 14 executes the drive control process. This drive control process is as illustrated in the processing flow in FIG. 3.

First, in step S21 in FIG. 3, the control unit 14 performs drive control on the throttle actuator 32 via the E/G_ECU 22 so as to commence control for causing the driving source to generate the driving force P (see reference sign [A] in FIG. 4).

When the drive control commences in this manner (reference sign [A] in FIG. 4), the towing vehicle M1 eventually starts to move. Accordingly, detection of the vehicle speed V commences (reference sign [B] in FIG. 4). Since the driving force P is controlled to gradually increase, the vehicle speed V also gradually increases with the change in the driving force P accordingly.

As the drive control commences (reference sign [A] in FIG. 4) and the vehicle speed V is detected (reference sign [B] in FIG. 4), the rope length L eventually starts to change (reference sign [C] in FIG. 4).

In step S22, the control unit 14 determines whether the state of the tow rope 50 can be confirmed by using the stereo camera 11 or the rear observation camera 15. If the state of the tow rope 50 cannot be confirmed by using the stereo camera 11 or the rear observation camera 15, the process proceeds to step S23. If the state of the tow rope 50 can be confirmed by using the stereo camera 11 or the rear observation camera 15, the process proceeds to step S24.

In step S23, for example, the control unit 14 checks a temporal change in the inter-vehicle distance between the towing vehicle M1 and the towed vehicle M2 by using the in-vehicle radar device 36. Accordingly, a temporal change in the inter-vehicle distance between the towing vehicle M1 and the towed vehicle M2 is confirmed. Then, based on this temporal change in the inter-vehicle distance, a process for presuming a change in the state of the tow rope 50 commences. The process then proceeds to step S25.

In step S24, the control unit 14 commences a process for continuously checking a temporal change in the state of the tow rope 50 by using the stereo camera 11 or the rear observation camera 15. The process then proceeds to step S25.

In step S25, the control unit 14 checks whether the driving force P has reached a predetermined value (first driving force P1) (see reference sign [D] in FIG. 4). If it is confirmed that the driving force P has reached the first driving force P1, the process proceeds to step S26. If the driving force P has not reached the first driving force P1, the control unit 14 waits until confirming that the driving force P has reached the first driving force P1.

In step S26, the control unit 14 executes drive control for continuously maintaining the first driving force P1 for a predetermined time period (see reference signs [D] to [F] in FIGS. 4, and see 6 and 7). During this period, the tow rope 50 is gradually stretched to change toward a linear state.

Therefore, for example, when the tow rope 50 is in the slack state illustrated in FIG. 5, the tow rope 50 stretches proportionally in accordance with the driving force P ([C] to [E] in FIG. 4). Then, for example, when the tow rope 50 eventually reaches a state close to the stretched state such that the tow rope 50 extends above the ground, as illustrated in FIG. 6, the stretching of the tow rope 50 becomes less pronounced (see a period from [E] to [F] in FIG. 4, and see reference sign L1 in FIG. 4).

When the driving force P is continuously maintained at the predetermined first driving force P1 for the predetermined time period, the vehicle speed V is also continuously maintained at a predetermined speed value (reference sign V1 in FIG. 4) for a predetermined time period (see a period from [D] to [E] in FIG. 4), as illustrated in FIG. 4.

In the period in which the stretching of the tow rope 50 is less pronounced (see the period from [E] to [F] in FIG. 4, and see reference sign L1 in FIG. 4), the vehicle speed V also decreases (see reference sign V2 in FIG. 4).

Subsequently, in step S27, the control unit 14 checks whether the tow rope 50 is in the natural length state (see reference sign [F] in FIGS. 4, and see 7). When the natural length state (contracted state) of the tow rope 50 is confirmed, the process proceeds to step S28. If the natural length state (contracted state) of the tow rope 50 is not confirmed, the control unit 14 waits until the natural length state of the tow rope 50 is confirmed.

Accordingly, the tow rope 50 changes into the natural length state (contracted state), as illustrated in FIG. 7, at a time point denoted by reference sign [F] in FIG. 4 (reference sign L2 in FIG. 4).

When the tow rope 50 changes into the natural length state (contracted state) illustrated in FIG. 7 in this manner (see reference signs [F] and L2 in FIG. 4), the control unit 14 subsequently executes drive control for increasing the driving force P by a predetermined amount in step S28 (see reference signs [F] to [G] and reference sign P2 in FIG. 4). Accordingly, the rope length L of the tow rope 50 is increased against its elasticity from the natural length state (contracted state; see FIG. 7), so that the tow rope 50 eventually changes into the stretched state (see reference sign L4 in FIGS. 4, and see 8).

In this case, the increasing driving force P causes the previously-decelerating vehicle speed V to slightly recover and increase (reference sign V3 in FIG. 4). In this case, the rope length L changes into the increasing direction from the loosened state in accordance with the movement of the towing vehicle M1 (i.e., the increase in the vehicle speed V), while the tow rope 50 eventually changes into a linearly stretched state (see reference sign [H] in FIGS. 4, and see 8).

Then, in step S29, the control unit 14 checks whether the driving force P has reached a predetermined value (second driving force P3) (see reference sign [G] in FIG. 4). When it is confirmed that the driving force P has reached the second driving force P3, the process proceeds to step S30. If the driving force P has not reached the second driving force P3, the control unit 14 waits until confirming that the driving force P has reached the second driving force P3.

In step S30, the control unit 14 executes drive control for continuously maintaining the second driving force P3 for a predetermined time period (see reference signs [G] to [K] in FIGS. 4, and see 8). During this period, the tow rope 50 changes into the stretched state (see reference sign L4 in FIGS. 4, and see 8) and is subsequently maintained in the stretched state.

During the period (reference signs [G] to [K] in FIG. 4) in which the driving force P is maintained at the second driving force P3, the driving force P of the towing vehicle M1 acts as a towing force for towing the towed vehicle M2 by using the tow rope 50. In this case, the rope length L is maintained in the stretched state (reference sing L5 in FIG. 4).

On the other hand, the vehicle speed V is temporarily reduced (reference sign V4 in FIG. 4) from a time point (reference sign L4 in FIG. 4) at which the stretched state is obtained as a result of the tow rope 50 being completely stretched. In this case, the towing force of the towing vehicle M1 is transmitted to the towed vehicle M2 through the tow rope 50. Eventually, the vehicle speed V rapidly recovers and increases (reference sign V5 in FIG. 4). Subsequently, the vehicle speed V is maintained at a fixed speed value (reference sign V6 in FIG. 4).

Accordingly, upon detection of a change pattern in which the vehicle speed V decreases (reference sign V4 in FIG. 4) and then recovers by increasing (reference sign V4 in FIG. 4), the towed vehicle M2 is regarded as having been extricated from the stuck state.

The control unit 14 detects such a change in the vehicle speed V, and determines that the towed vehicle M2 has been extricated from the stuck state. In this case, the control unit 14 functions as an extrication determination device.

After step S30, the process exits the processing flow (return), and returns to the original process in FIG. 2.

Referring back to FIG. 2, in step S5, the control unit 14 performs an extrication determination process. As described above, the extrication determination process to be performed here involves checking whether there is a predetermined pattern (from a decrease in speed to recovery by an increase in driving force) in the change in the vehicle speed V. When it is confirmed that the towed vehicle M2 has been extricated from the stuck state, the process proceeds to step S6. If it is not confirmed that the towed vehicle M2 has been extricated from the stuck state, the process proceeds to step S10.

In step S6, the control unit 14 executes braking control by performing drive control on the brake actuator 34 via the BK_ECU 24. At the same time, the control unit 14 causes the driving source to stop generating the driving force P by performing drive control on the throttle actuator 32 via the E/G_ECU 22 (see reference sign P4 in FIG. 4). Accordingly, the towing vehicle M1 decreases in vehicle speed V and eventually stops (see reference sign V7 in FIG. 4).

A driver who drives the towed vehicle M2 stops the towed vehicle M2 by performing a braking operation at a timing substantially the same as the timing of the braking control performed on the towing vehicle M1.

At this time point, the tow rope 50 is maintained in the stretched state. Then, in step S7, the control unit 14 performs travel control for moving the towing vehicle M1 rearward by a predetermined distance. This rearward travel control involves, for example, driving the hydraulic control circuit 33 via the T/M_ECU 23 and then shifting the automatic transmission to the reverse gear. Subsequently, drive control is performed on the throttle actuator 32 via the E/G_ECU 22, so that the driving source is caused to generate the driving force P for a predetermined time period. Accordingly, the towing vehicle M1 travels rearward by the predetermined distance. With this rearward drive control, the inter-vehicle distance between the towing vehicle M1 and the towed vehicle M2 is reduced. Consequently, the tow rope 50 changes into the loosened state. The user removes the tow rope 50 from the towing vehicle M1 and the towed vehicle M2, so as to decouple the two vehicles (M1 and M2) from each other. Then, the user uses the mode switch included in the HMI 31 to perform a towing-mode cancelling operation.

Subsequently, in step S8, the control unit 14 checks whether the tow rope 50 has been removed. When it is confirmed that the tow rope 50 has been removed, the process proceeds to step S9. If the tow rope 50 has not been removed, the control unit 14 waits until confirming that the tow rope 50 has been removed.

In step S9, the control unit 14 checks whether the towing mode has been cancelled. The checking performed here is performed by detecting a towing-mode off signal generated in response to the towing-mode cancelling operation. Upon detecting the towing-mode off signal, the control unit 14 cancels the towing mode of the travel control apparatus 1 and switches to the normal travel mode. Subsequently, the series of steps is completed, and the control unit 14 exits the towing control process.

On the other hand, if extrication is not confirmed in the extrication determination process in step S5 described above, the control unit 14 first performs rearward drive control in step S10 to perform the towing operation again. The rearward drive control to be performed here is substantially similar to the processing control in step S7 described above.

Subsequently, in step S11, the control unit 14 checks whether the number of towing attempts has exceeded a prescribed number, or whether the set driving force P has reached a prescribed upper limit value.

In the towing control process performed in the towing mode, the towing operation is automatically performed repeatedly multiple times. If extrication is not achieved in a single towing attempt, a subsequent towing attempt is performed (reference signs P3 to P6 in FIG. 4) while slightly increasing the driving force P (reference signs P2 to P5 in FIG. 4), as will be described later. If extrication is still difficult after a prescribed number of attempts (e.g., three attempts), the towing mode is terminated.

Instead of limiting the number of attempts to a prescribed number, for example, a prescribed upper limit value may be set for the driving force P, and the attempt may be performed until the driving force P set for every attempt reaches the upper limit value. In this case, when the set towing driving force P exceeds the upper limit value, the towing mode may be terminated.

In the towing control process performed automatically in this manner, the number of towing attempts or the upper limit for the towing driving force P is set in advance, so that repeated wasteful operations are suppressed, and a towing operation using an excessive driving force is suppressed.

When it is confirmed in step S13 described above that the number of towing attempts has exceeded the prescribed number or that the set towing driving force P has exceeded the upper limit value, the process proceeds to step S12. If the number of towing attempts has not exceeded the prescribed number or if the towing driving force P has not exceeded the upper limit value, the process proceeds to step S13.

In step S12, the control unit 14 uses, for example, the display device included in the HMI 31 to notify the user that the towed vehicle M2 is not towable. Subsequently, the series of steps is completed, and the control unit 14 exits the towing control process.

In step S13, the control unit 14 performs a process for changing the driving force characteristics. The changing process to be performed here involves setting the currently-set second driving force P3 to a slightly higher second driving force P5.

According to this setting changing process, in step S28 to step S29 in the drive control process (FIG. 3) to be performed next, the drive control for increasing the driving force P by a predetermined amount is set to reference signs [F] to [H] in FIG. 4 (reference signs P2 + P5 in FIG. 4), and to a control process for maintaining the second driving force P5 (see reference sign P6 in FIG. 4). Consequently, a towing operation is attempted using a towing driving force P larger than that in the previous towing operation.

The embodiment described above provides a vehicle towing control device that controls a towing operation for towing and extricating a vehicle, such as an automobile, when the vehicle is stuck on a snowy road, an unpaved road, or the like, and that can automatically and appropriately perform the towing operation of the vehicle without waste and undue force.

As illustrated in FIGS. 5 to 8, in this embodiment, the tow rope 50 has one end coupled to the rear tow hook 51 of the towing vehicle M1 and the other end coupled to the front tow hook 52 of the towed vehicle M2, so as to couple the two vehicles (M1 and M2) to each other.

Alternatively, the tow rope 50 used when performing a towing operation is not limited to the above configuration and may be coupled between other combinations.

For example, the tow rope 50 may be coupled between the front tow hook of the towing vehicle M1 and the front tow hook of the towed vehicle M2. As another alternative, for example, the tow rope 50 may be coupled between the front tow hook of the towing vehicle M1 and the rear tow hook of the towed vehicle M2. As yet another alternative, for example, the tow rope 50 may be coupled between the rear tow hook of the towing vehicle M1 and the rear tow hook of the towed vehicle M2. An optimal configuration may be set by appropriately changing the combination depending on the two vehicles (M1 and M2) or the condition surrounding the vehicles.

The disclosure is not limited the embodiment described above, and various modifications and applications can be made without departing from the spirit of the disclosure. Furthermore, the above embodiment includes various stages of the disclosure, and various aspects of the disclosure can be derived by appropriate combinations of disclosed components. For example, even when some components are deleted from all of the components indicated in the above embodiment, if the problem to be solved by the disclosure can still be solved and the effects of the disclosure can still be obtained, a configuration with the deleted components can be derived as an aspect of the disclosure. Furthermore, components across different embodiments may be appropriately combined. The disclosure is not restricted to a specific embodiment except as defined by the appended claims.

The embodiment of the disclosure can provide a vehicle towing control device that controls a towing operation for towing and extricating a vehicle, such as an automobile, when the vehicle is stuck on a snowy road, an unpaved road, or the like, and that can safely and reliably extricate the stuck vehicle by automatically and appropriately performing towing control even when a user is not accustomed to a vehicle towing operation.

The vehicle towing control device illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the vehicle towing control device. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. A vehicle towing control device configured to be provided in a towing vehicle configured to tow and extricate a towed vehicle that is a vehicle in a stuck state, the vehicle towing control device comprising:
a tow-rope-state-information acquisition device configured to acquire information regarding a state of a tow rope used for coupling the towed vehicle and the towing vehicle to each other;
a vehicle speed acquisition device configured to acquire information regarding a vehicle speed of the towing vehicle; and
a driving force control device configured to control a driving force of a driving source of the towing vehicle,
wherein the driving force control device is configured to control the driving force of the driving source based on change information about the state of the tow rope or change information about the vehicle speed of the towing vehicle.

2. The vehicle towing control device according to claim 1,
wherein the tow-rope-state-information acquisition device comprises one or both of an imaging device and a distance measurement device.

3. The vehicle towing control device according to claim 1, further comprising:
an extrication determination device configured to determine whether the towed vehicle is extricated from the stuck state based on the change information about the vehicle speed,
wherein the driving force control device is configured to, when the extrication determination device determines that the towed vehicle is not extricated from the stuck state, control the driving force of the driving source again by increasing the driving force by a predetermined amount.

4. The vehicle towing control device according to claim 1,
wherein the tow rope comprises elasticity and is stretchable and contractible, and
wherein the change information about the vehicle speed comprises a change pattern in which the vehicle speed decreases and subsequently recovers by increasing.

5. The vehicle towing control device according to claim 3,
wherein the driving force control device is configured to, when extrication of the towed vehicle from the stuck state is confirmed, perform braking control on the towing vehicle.

6. A vehicle towing control device configured to be provided in a towing vehicle configured to tow and extricate a towed vehicle that is a vehicle in a stuck state, the vehicle towing control device comprising:
circuitry configured to
acquire information regarding a state of a tow rope used for coupling the towed vehicle and the towing vehicle to each other;
acquire information regarding a vehicle speed of the towing vehicle;
control a driving force of a driving source of the towing vehicle; and
control the driving force of the driving source based on change information about the state of the tow rope or change information about the vehicle speed of the towing vehicle.
